(19) United States
(12) Patent Application Publication
(10) Pub. No.: US 2017/0149318 A1
(43) Pub. Date: May 25, 2017

(54) Single Phase Permanent Magnet Brushless Motor

(71) Applicant: Johnson Electric S.A., Murten (CH)

(72) Inventors: Yue LI, Hong Kong (CN); Wai Lun Allan KWAN, Hong Kong (CN); Mao Xiong JIANG, Shenzhen (CN); Jing Xin SHI, Shenzhen (CN); Chui You ZHOU, Shenzhen (CN); Ji Cheng PAN, Shenzhen (CN); Ji Dong CHAI, Shenzhen (CN); Wan You WANG, Shenzhen (CN); Yan Fang ZHI, Shenzhen (CN)

(21) Appl. No.: 15/357,631

(22) Filed: Nov. 21, 2016

(30) Foreign Application Priority Data
Nov. 19, 2015 (CN) 2015 1081 2971.0

(51) Int. Cl. H02K 19/04; H02K 1/27; H02K 21/16; H02K 1/14

(52) U.S. Cl. CPC H02K 19/04; H02K 1/146; H02K 1/2706; H02K 21/16

(57) ABSTRACT

A single phase permanent magnet brushless motor includes a stator and a rotor. The stator includes an outer housing, a stator core mounted in the outer housing, and windings wound around the stator core. The stator core includes a yoke and a plurality of poles extending inwardly from the yoke. The yoke is fixed to the outer housing by welding. Reliability of the present motor is enhanced.

### CROSS REFERENCE TO RELATED APPLICATIONS

This non-provisional patent application claims priority under 35 U.S.C. §119(a) from Patent Application No. 201510812971.0 filed in The People's Republic of China on Nov. 19, 2015.

### FIELD OF THE INVENTION

This invention relates to the field of motors, and in particular, to a single phase permanent magnet brushless motor being capable of rotating at high speed.

### BACKGROUND OF THE INVENTION

A stator core of a single phase permanent magnet brushless motor in the art is usually assembled into an outer housing by gluing, which has the risk of falling off and the problem of poor heat dissipation. The present invention aims to provide a single phase permanent magnet brushless motor to solve the above problems.

### SUMMARY OF THE INVENTION

Thus, there is a desire for a motor with improved reliability.

In one aspect, a single phase permanent magnet brushless motor is provided which includes a stator and a rotor rotatable relative to the stator. The stator includes an outer housing, a stator core mounted in the outer housing, and windings wound around the stator core. The stator core includes a yoke and a plurality of poles extending inwardly from the yoke. The yoke is fixed to the outer housing by welding.

Preferably, the plurality of poles comprises a first pole and a second pole; an end surface of the first pole comprises a first arc surface, an end surface of the second pole comprises a second arc surface, and the first arc surface and the second arc surface face each other and cooperatively define a receiving space; the rotor is received in the receiving space and comprises a shaft and permanent magnetic poles fixed on the shaft.

Preferably, the yoke comprises a plurality of connecting parts, the outer housing defines a plurality of slots corresponding to the connecting parts of the yoke, and the connecting parts are fixed to peripheries of corresponding slots of the yoke by welding.

Preferably, the outer housing comprises an open end for mounting the stator core therein, an inner surface of the outer housing forms protruding supporting stages for supporting the stator core.

Preferably, the slots are located between the supporting stages and the open end of the outer housing.

Preferably, the connecting parts extend outwardly from the yoke.

Preferably, the connecting parts extend outwardly from an outer periphery of the yoke along a radial direction of the motor.

Preferably, the outer housing is barrel-shaped, and the connecting parts form arc-shaped outer surfaces or chamfered outer surfaces for contacting an inner surface of the outer housing.

Preferably, the yoke is ring-shaped, and the first pole and the second pole are engaged with the yoke.

Preferably, the first pole forms a dovetail end engaged with the yoke, and the second pole forms a dovetail end engaged with the yoke.

Preferably, the stator core comprises two splicing F-shaped members, one of the F-shaped members forms one half of the yoke and the first pole, and the other one of the F-shaped members forms the other half of the yoke and the second pole.

Preferably, a dovetail connecting groove is defined in one end of each F-shaped member, and a dovetail connecting portion is formed on the other end of each

F-shaped member, the dovetail connecting groove and connecting portion of one of the F-shaped members are respectively engaged with the dovetail connecting portion and connecting groove of the other one of the F-shaped members.

Preferably, a gap is defined between the yoke and an inner surface of the outer housing to form an axial passage, the outer housing defines a plurality of openings communicating with the axial passage.

Preferably, the stator further comprises a supporting bracket mounted in the outer housing, and a bearing seat mounted to at least one of the supporting bracket and the outer housing, the rotor comprises a shaft supported by the bearing seat through a bearing.

Preferably, the supporting bracket has a cross shape, a sidewall of the outer housing defines four openings, with connecting walls formed between the openings, the supporting bracket is fixed to the connecting walls by welding.

In another aspect, a single phase permanent magnet brushless motor is provided which includes a stator and a rotor. The stator includes an outer housing, a supporting bracket mounted in the outer housing, a bearing seat mounted to at least one of the supporting bracket and the outer housing, a stator core mounted in the outer housing, and windings wound on the stator core. The rotor is rotatably coupled to the stator and includes a shaft being supported by the bearing seat through a bearing.

Preferably, the supporting bracket has a cross shape, a sidewall of the outer housing defines four openings, with connecting walls formed between the openings, the supporting bracket is fixed to the connecting walls by welding.

Preferably, the stator core and the outer housing are connected through welding.

By implementing the present invention, reliability of the motor is enhanced, and heat dissipation inside the motor is improved.

### BRIEF DESCRIPTION OF THE DRAWINGS

The present invention will now be described further, by way of example only, with reference to the accompanying drawings. In the drawings, elements with similar constructions or functions are labeled the same. It should be understood that dimensions of components and features shown in the drawings are generally chosen for convenience and clarity of presentation and are not necessarily shown to scale.

FIG. 1 is a schematic view of a single phase permanent magnet brushless motor according to a first embodiment of the present invention.

FIG. 2 is a schematic view of an outer housing of the single phase permanent magnet brushless motor shown in FIG. 1.

FIG. 3 is a schematic view showing a supporting bracket of the single phase permanent magnet brushless motor assembled into the outer housing.

FIG. 4 is a schematic view of the single phase permanent magnet brushless motor of FIG. 1, with the outer housing removed.

FIG. 5 shows the single phase permanent magnet brushless motor of FIG. 1 viewed from another aspect, with a circuit board removed.

FIG. 6 is a sectional, schematic view of the single phase permanent magnet brushless motor of FIG. 1, with the circuit board removed.

FIG. 7 is a schematic view of a stator core and stator windings of the single phase permanent magnet brushless motor of FIG. 1.

FIG. 8 is a schematic view of the stator core shown in FIG. 7.

FIG. 9 is a schematic view of another construction of the stator core of FIG. 7.

FIG. 10 is a schematic view of a stator core and stator windings of a single phase permanent magnet brushless motor in accordance with a second embodiment.

FIG. 11 is a schematic view of a single phase permanent magnet brushless motor according to a third embodiment.

### DETAILED DESCRIPTION OF THE PREFERRED EMBODIMENTS

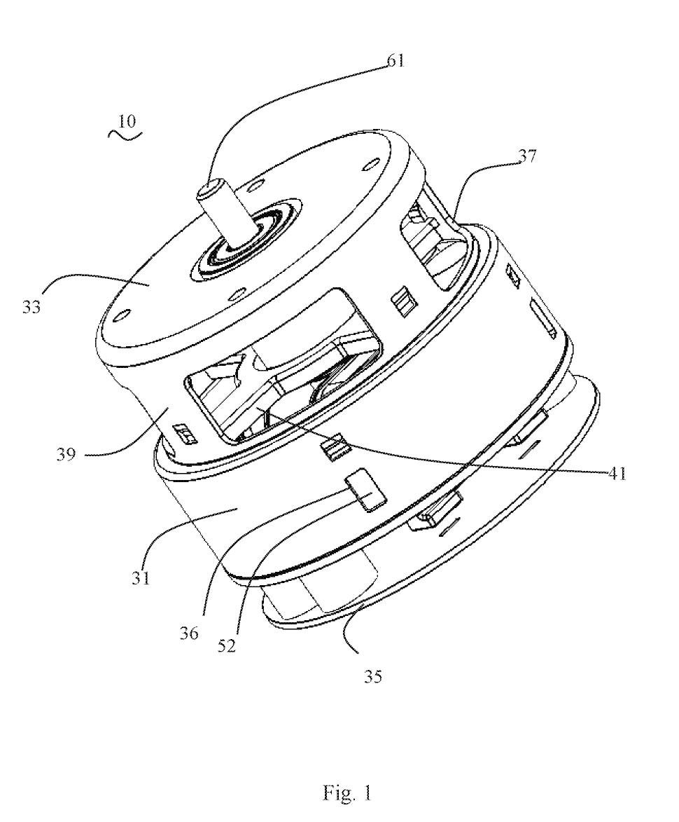

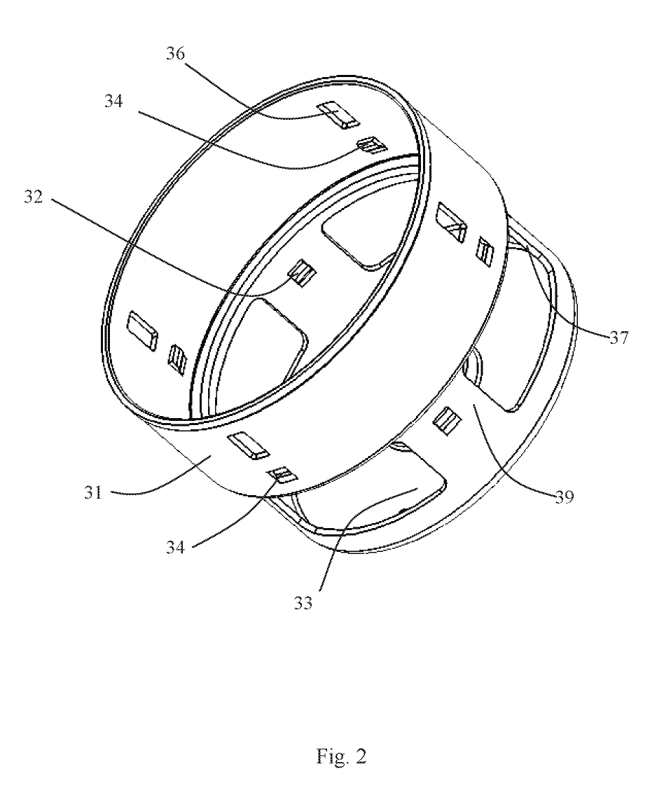

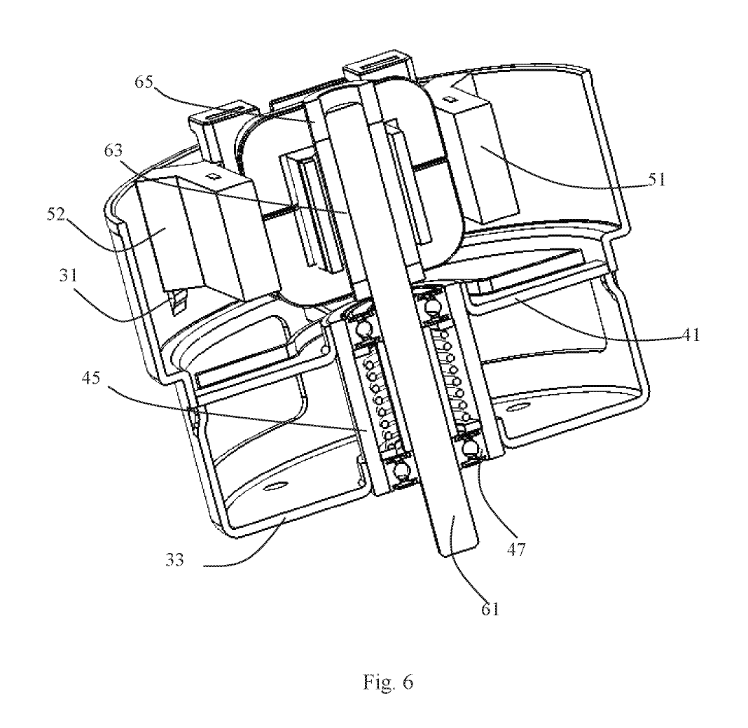

Referring to FIG. 1 and FIG. 2, a single phase permanent magnet brushless motor according to an embodiment of the present invention includes a stator and a rotor. The stator includes an outer housing 31. The outer housing 31 forms a cover 33 at one end thereof and is open at the other end. The stator further includes a circuit board 35 mounted at the open end of the outer housing 31, a stator core 51 made of a magnetic-conductive soft magnetic material mounted in the outer housing 31, and windings 53 wound around the stator core 51. The rotor includes a shaft 61, and permanent magnetic poles (see permanent magnetic poles 63 of FIG. 6) fixed on the shaft 61. The rotor is rotatably mounted within the stator, and is capable of rotating relative to the stator. An output end of the shaft 61 can be connected to a driven member such as an impeller.

Referring to FIG. 2, in this embodiment, the outer housing 31 is barrel-shaped. A portion of an annular sidewall of the outer housing 31 adjacent the cover 33 defines a plurality of openings 37, with connecting walls 39 formed between the openings 37. The openings 37 of the outer housing 31 communicate with a passage defined between the stator core 51 and an inner surface of the outer housing 31, for facilitating dissipation of heat inside the motor.

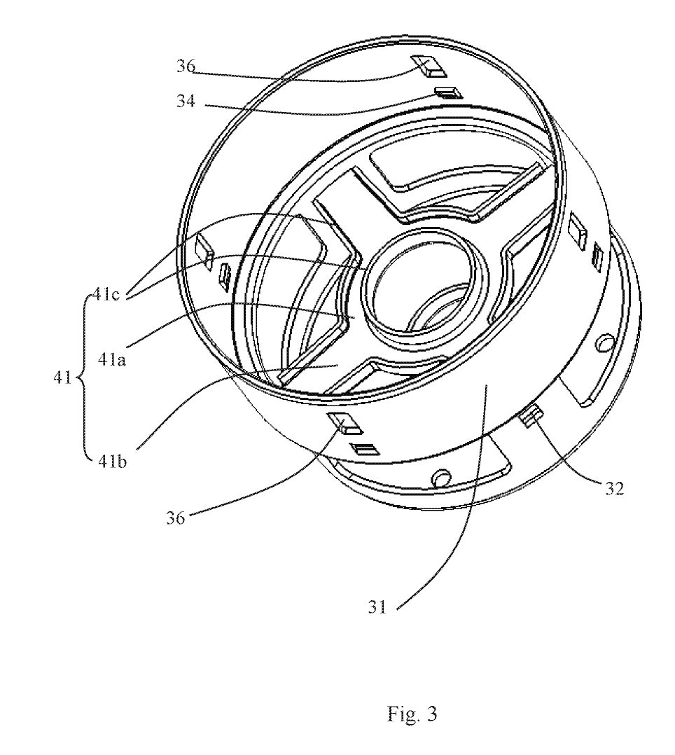

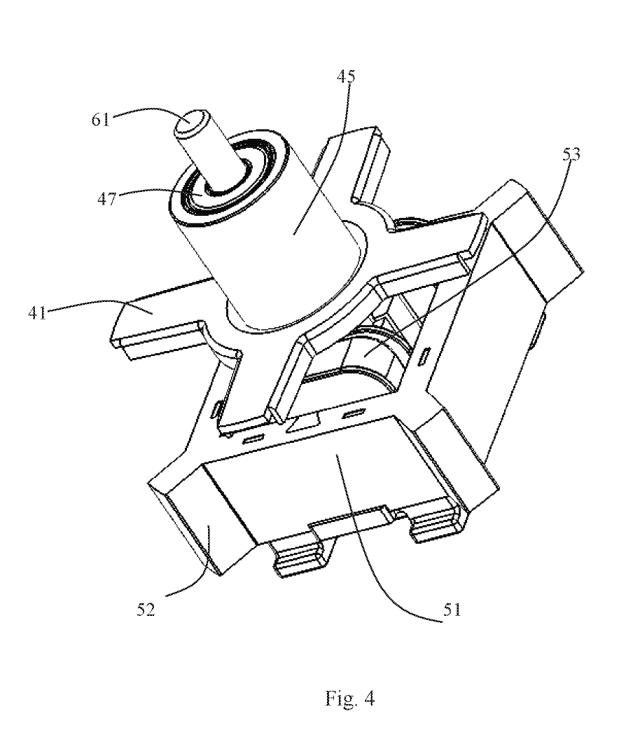

Referring to FIG. 2 and FIG. 3, a supporting bracket 41 is mounted in the outer housing 31. The supporting bracket 41 includes a ring portion 41a defining a through hole therein, and a plurality of connecting members 41b extending outwardly from the ring portion 41a. The ring portion 41a is used to support a bearing seat 45 (see FIG. 4). The connecting members 41b are coupled to the inner surface of the outer housing 31. Specifically, a plurality of support portions 32 are formed on the inner surface of the outer housing 31 for supporting the connecting members 41b of the supporting bracket 41, thereby separating the supporting bracket 41 from the cover 33 by a predetermined distance. Preferably, the connecting members 41b and the inner surface of the outer housing 31 are fixed by welding. A flange 41c is formed at edges of the ring portion 41a and the connecting members 41b for enhancing strength of the supporting bracket 41. Preferably, the supporting bracket 41 has a cross shape, including four connecting members 41b being fixedly connected to the connecting walls 39 of the outer housing 31, respectively.

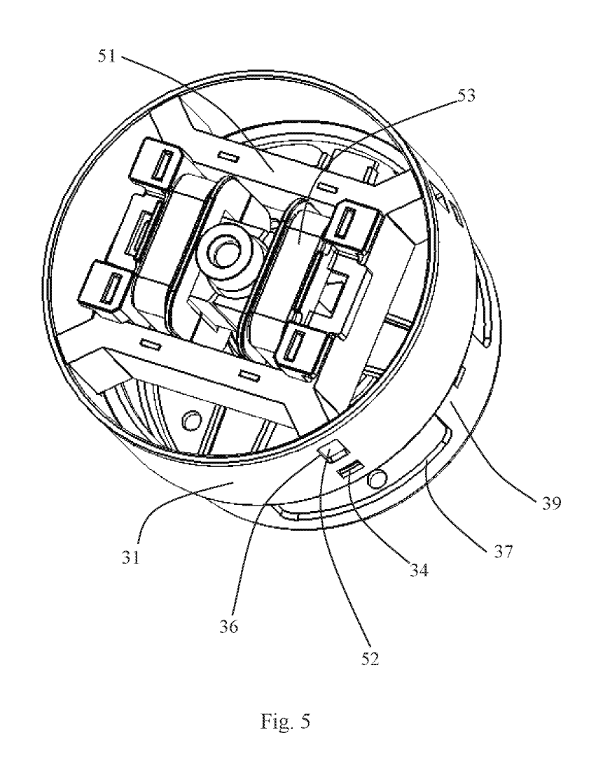

Referring to FIGS. 2, 4 and 5, the stator core 51 can be mounted into the outer housing 31 through the open end of the outer housing 31. The inner surface of the outer housing 31 forms a plurality of protruding supporting stages 34 for supporting the stator core 51. Supporting surfaces of the supporting stages 34 are coplanar. The supporting stages 34 can be formed by stamping the outer housing 31 inwardly. It should be understood that an annular step of the inner surface of the outer housing 31 can also be used as the supporting stages 34. In this embodiment, the supporting stages 34 are spaced from each other along a circumferential direction of the outer housing 31. A slot 36 is defined between each supporting stage 34 and the open end of the outer housing 31. Preferably, a center line of each supporting stage 34 is coincident with that of the corresponding slot 36. The stator core 51 forms a plurality of connecting parts 52. Preferably, the connecting parts 52, the supporting stages 34, and the slots 36 are the same in number. Each connecting part 52 is aligned with one corresponding slot 36 and close to the inner surface of the outer housing 31. Preferably, each connecting part 52 has a width along the circumferential direction of the stator core 51 larger than that of the corresponding slot 36. The stator core 51 and the outer housing 31 are welded together through laser welding at peripheries of the slots 36 after the stator core 51 is mounted.

Referring to FIG. 4 and FIG. 6, the single phase permanent magnet brushless motor further includes a rolling supporting structure mounted to the cover 33 and the supporting bracket 41. The rolling supporting structure is for rolling support of the rotor. In this embodiment, the rolling supporting structure includes the bearing seat 45 fixed to the cover 33 of the outer housing 31 and the supporting bracket 41, and a rolling bearing 47 mounted in the bearing seat 45. The rolling bearing 47 supports the shaft 61 of the rotor. Preferably, the bearing seat 45 is hollow, cylindrical-shaped. The rolling bearing 47 and the bearing seat 45 are fixed to each other by welding. The bearing seat 45 and the supporting bracket 41 are fixed to each other by welding. The cover 33 of the outer housing 31 defines an opening. One end of the bearing seat 45 is inserted and welded in the opening of the cover 33 of the outer housing 31. The permanent magnetic poles 63 are fixed on the shaft 61. A counterweight 65 is positioned at an end of the permanent magnetic poles 63 away from the cover 33. In this embodiment, the permanent magnetic poles 63 are integrally formed by sintered neodymium-iron-boron, being cylindrical in shape. Optionally, the permanent magnetic poles 63 and the counterweight 65 can be fixed within a sleeve to avoid spattering of fragments of the permanent magnetic poles 63 in case the permanent magnetic poles 63 break during high speed rotation of the rotor. A sensor, such as Hall sensor, is installed on the circuit board 35 near an axial end of the permanent magnetic poles 63. The axial end of the permanent magnetic poles 63 extends beyond that of the stator core 51, preferably, by 2 mm. Thus, the axial end of the permanent magnetic poles 63 beyond the stator core 51 may function as a magnetic induction ring which cooperates with the Hall sensor so that a controller of the motor can determine a position of the rotor.

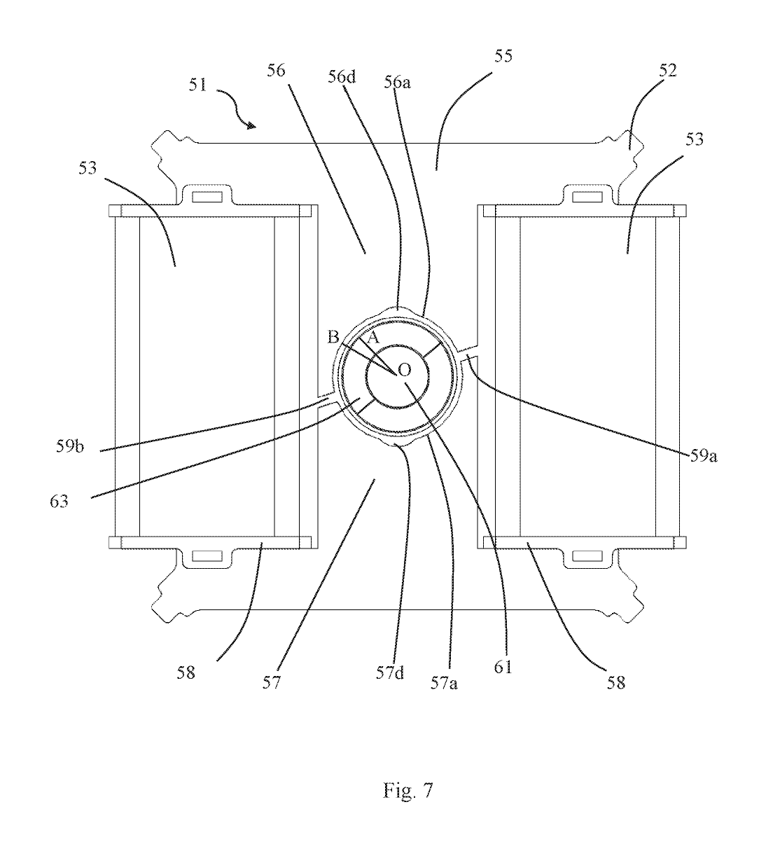

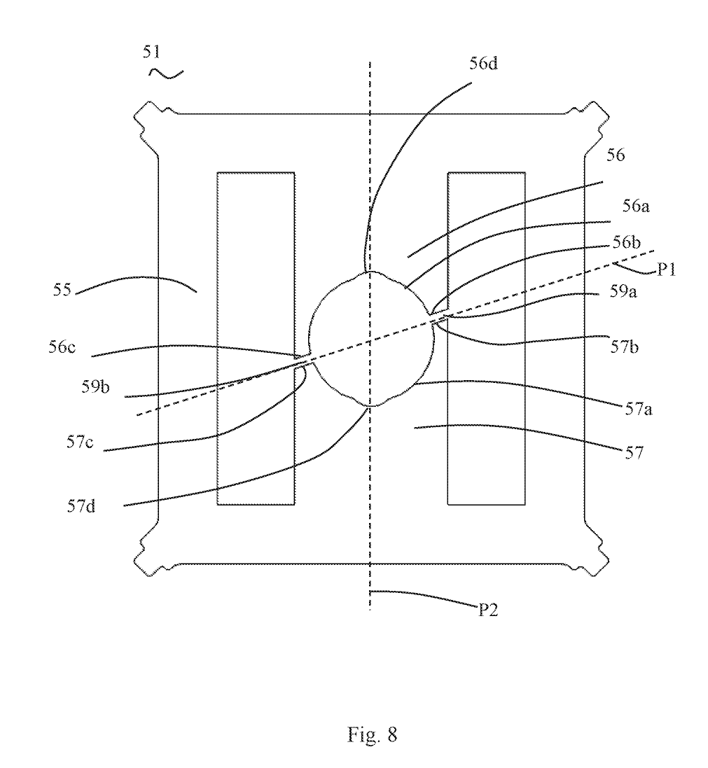

Referring to FIG. 7 and FIG. 8, the stator core 51 includes a ring-shaped (the ring shape as used in this disclosure includes a closed shape such as rectangular and circular shape) yoke 55, and a first pole 56 and a second pole 57 extending inwardly from the yoke 55. Preferably, the first pole 56 and the second pole 57 have the same width. Center lines of the first and second poles 56, 57 are coincident with each other, and end surfaces of the first and second poles 56, 57 are opposed to each other. In this embodiment, the stator includes two windings 53 wound around portions of the yoke 55 at opposite sides of the first and second poles 56, 57, respectively. When the windings 53 are energized, each winding 53 generates a magnetic loop through the rotor, such that a total of two magnetic loops with different paths are formed. An insulating bracket 58 can be arranged between the windings 53 and the stator core 51.

In this embodiment, a cross section of the stator core 51 perpendicular to the axial direction is generally θ-shaped. The protruding connecting parts 52 are formed on corners of the stator core 51. Preferably, a surface of each connecting part 52 proximate to the inner surface of the outer housing 31 has a shape matching the shape of the inner surface of the outer housing 31.

In this embodiment, the end surface of the first pole 56 includes a first arc surface 56a, and first and second plane surfaces 56b, 56c at opposite sides of the first arc surface 56a, respectively.

The end surface of the second pole 57 includes a second arc surface 57a, and third and fourth plane surfaces 57b, 57c at opposite sides of the second arc surface 57a, respectively.

The first arc surface 56a and the second arc surface 57a face each other and cooperatively form a receiving space for receiving the rotor, and particularly for receiving the permanent magnetic poles 63. The first plane surface 56b and the third plane surface 57b are substantially in parallel, and define a first slot 59a therebetween with uniform width. The second plane surface 56c and the fourth plane surface 57c are substantially in parallel, and define a second slot 59b therebetween with uniform width. The first and second slots 59a, 59b function as magnetic bridges with large magnetic reluctance between the first pole 56 and the second pole 57 to avoid magnetic short-circuit.

Preferably, the width of the first slot 59a (i.e. a size of the first slot 59a along a direction perpendicular to the first plane surface 56b) is equal to that of the second slot 59b (i.e. a size of the second slot 59b along a direction perpendicular to the second plane surface 56c). The centerlines of the first and second slots 59a, 59b are coincident with each other, and pass through the center O of the shaft 61 of the rotor. The centerline P1 of the first and second slots 59a, 59b is inclined with respect to a centerline P2 of the first and second poles 56, 57 (the centerline P2 likewise passes through the center O of the rotor). An included angle between the centerlines P1 and P2 is less than or equal to 90°. When the included angle between the centerlines P1 and P2 is less than 90°, the first pole 56 is asymmetric with respect to the centerline P2 thereof, and the second pole 57 is also asymmetric with respect to the centerline P2 thereof, which can reduce an induced electromotive force of the motor, thereby increasing an output torque of the motor.

The first arc surface 56a defines an arc-shaped first recess 56d, and the second arc surface 57a defines an arc-shaped second recess 57d. The size, shape, and position of the first and second recesses 56d, 57d can be changed according to needs. The provision of the first and second recesses 56d, 57d may be used to determine an initial position of the rotor. In this embodiment, there are two permanent magnetic poles 63. When the rotor is at the initial position, a centerline OA of one of the permanent magnetic poles 63 (south pole or north pole) is deviated from a centerline OB of a portion of the first arc surface 56a between the first recess 56d and second slot 59b. In this embodiment, the centerline OA of the permanent magnetic pole 63 is closer to the first recess 56d. Thus, as shown in FIG. 7, the rotor is easier to start along a counter-clockwise direction than along a clockwise direction. Alternately, the centerline OA of the permanent magnetic pole 63 can also be designed to be closer to the second slot 59b, and thus the rotor is easier to start along the clockwise direction than the counter-clockwise direction.

Preferably, portions of the first arc surface 56a and the second arc surface 57a are substantially located on a same cylindrical surface except for the first and second recesses 56d, 57d. The outer surfaces of the permanent magnetic poles 63 are substantially located on a same cylindrical surface radially opposed to the first arc surface56a and the second arc surface 57a. Thus, a substantially uniform air gap is formed between the stator and the rotor. The substantially uniform air gap as used in this disclosure means that the air gap between most part of the rotor and most part of the stator is uniform, and only a few part of the air gap, such as the part of the air gap corresponding to the first and second recesses 56d, 57d, the first and second slots 59a, 59b, and chamfers at the distal ends of the permanent magnetic poles 63, is non-uniform.

Preferably, the width of the first slot 59a is less than three times of the uniform part of the air gap between the rotor and the stator. More preferably, the width of the first slot 59a is less than two times of the uniform part of the air gap between the rotor and the stator.

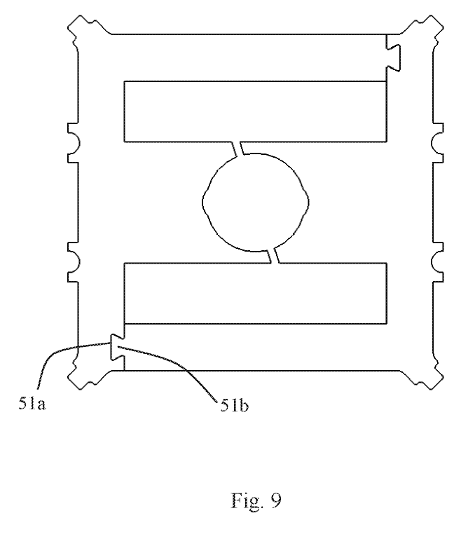

Referring to FIG. 9, the stator core can consist of two F-shaped members with identical shape, one of which forms one half of the yoke and the first pole, and the other one of which forms the other half of the yoke and the second pole. Each member defines a dovetail connecting groove 51a in one end thereof, and includes a dovetail connecting portion 51b at the other end thereof. During assembly, the dovetail connecting groove 51a and connecting portion 51b of one member are respectively engaged with the dovetail connecting portion 51b and connecting groove 51a of the other member.

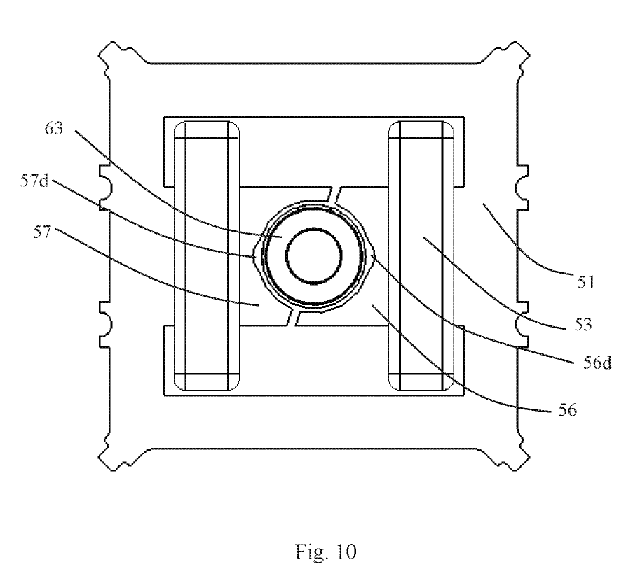

Referring to FIG. 10, in another embodiment, the stator windings 53 can be wound around the first pole 56 and the second pole 57.

In the present invention, the two windings 53 can be connected to a single phase current supply, such that the single phase permanent magnet brushless motor of the present invention may be used as a single phase brushless direct current motor, which is especially suitable for high speed applications (e.g. higher than 100 krpm) such as hand-dryer or vacuum cleaner. The maximum speed of the motor of the present invention can be 120 krpm. It should be understood that the design of the present invention can also be used in single phase synchronous motors.

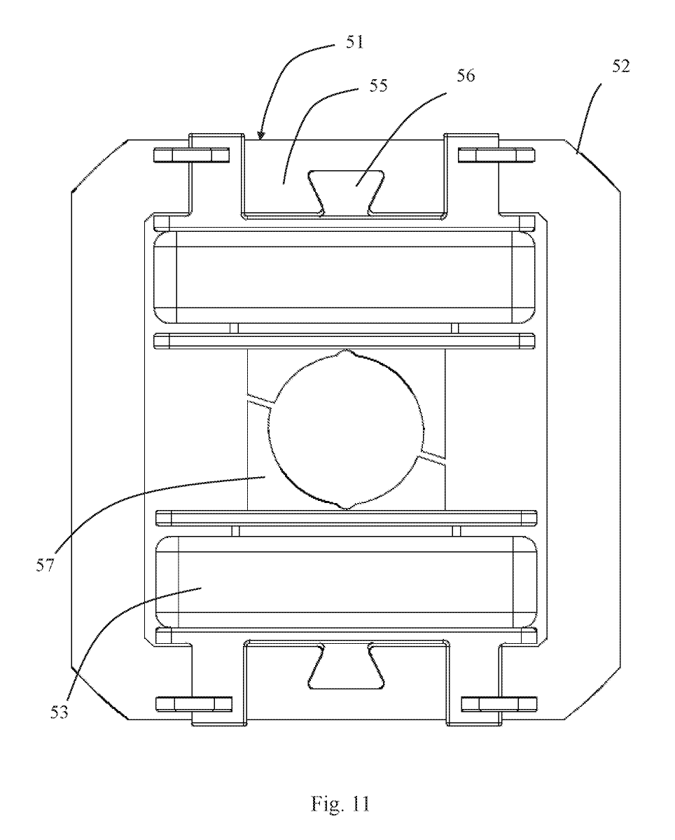

Referring to FIG. 11, in an alternative embodiment, the stator core 51 includes an integral ring-shaped yoke 55, and first and second poles 56, 57 assembled to the yoke 55. The first and second poles 56, 57 each form a dovetail end engaged with the yoke 55. The windings 53 are wound around the first pole 56 and the second pole 57. In this embodiment, the yoke 55 is square in shape, and corners of the yoke 55 function as connecting parts 52 and are trimmed to form planar or curved outer surfaces, for facilitating connecting or being arranged proximate to the inner surface of the outer housing 31, and hence facilitating welding the stator core 51 to the outer housing 31 at the peripheries of the slots 36.

The yoke 55 and the inner surface of the outer housing 31 define a gap therebetween, which forms an axial passage. The openings 37 of the outer housing 31 communicate with the axial passage to improve heat dissipation inside the motor.

In this embodiment, the stator core 51 and the outer housing 31 are connected through welding, which improves reliability of the connection as well as heat transfer. In addition, the axial passage formed between the outer side of the stator core 51 and the inner side of the outer housing 31 further improves heat dissipation of the motor.

Various other modifications can be apparent to persons skilled in the field without departing from the scope of the invention. For example, the first and second slots 59a, 59b may not extend through the first and second poles 56, 57 along the radial direction, and can be defined in inner or outer surfaces of the first and second poles 56, 57 as long as the high magnetic reluctance magnetic bridges are formed between the first and second poles 56, 57. The shape of the first and second slots 59a, 59b can be changed, and the width of the first and second slots 59a, 59b can be uniform or non-uniform. When the width is non-uniform, the width of the first and second slots 59a, 59b refers to the width between neighboring ends of the inner surfaces of the first and second poles 56, 57. The shape of the first and second recesses 56d, 57d also can be changed. In addition to the square shape, the cross section of the stator core 51 can be of another ring shape such as circular shape. All of such modifications should fall within the scope of the present invention.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A single phase permanent magnet brushless motor, comprising:
a stator comprising an outer housing, a stator core mounted in the outer housing, and windings wound around the stator core; the stator core comprising a yoke and a plurality of poles extending inwardly from the yoke, the yoke being fixed to the outer housing by welding; and
a rotor rotatable relative to the stator.

2. The single phase permanent magnet brushless motor of claim 1, wherein the plurality of poles comprises a first pole and a second pole; an end surface of the first pole comprises a first arc surface, an end surface of the second pole comprises a second arc surface, and the first arc surface and the second arc surface face each other and cooperatively define a receiving space; the rotor is received in the receiving space and comprises a shaft and permanent magnetic poles fixed on the shaft.

3. The single phase permanent magnet brushless motor of claim 1, wherein the yoke comprises a plurality of connecting parts, the outer housing defines a plurality of slots corresponding to the connecting parts of the yoke, and the connecting parts are fixed to peripheries of corresponding slots of the yoke by welding.

4. The single phase permanent magnet brushless motor of claim 3, wherein the outer housing comprises an open end for mounting the stator core therein, an inner surface of the outer housing forms protruding supporting stages for supporting the stator core.

5. The single phase permanent magnet brushless motor of claim 4, wherein the slots are located between the supporting stages and the open end of the outer housing.

6. The single phase permanent magnet brushless motor of claim 3, wherein the connecting parts extend outwardly from the yoke.

7. The single phase permanent magnet brushless motor of claim 6, wherein the connecting parts extend outwardly from an outer periphery of the yoke along a radial direction of the motor.

8. The single phase permanent magnet brushless motor of claim 3, wherein the outer housing is barrel-shaped, and the connecting parts form arc-shaped outer surfaces or chamfered outer surfaces for contacting an inner surface of the outer housing.

9. The single phase permanent magnet brushless motor of claim 2, wherein the yoke is ring-shaped, and the first pole and the second pole are engaged with the yoke.

10. The single phase permanent magnet brushless motor of claim 9, wherein the first pole forms a dovetail end engaged with the yoke, and the second pole forms a dovetail end engaged with the yoke.

11. The single phase permanent magnet brushless motor of claim 2, wherein the stator core comprises two splicing F-shaped members, one of the F-shaped members forms one half of the yoke and the first pole, and the other one of the F-shaped members forms the other half of the yoke and the second pole.

12. The single phase permanent magnet brushless motor of claim 11, wherein a dovetail connecting groove is defined in one end of each F-shaped member, and a dovetail connecting portion is formed on the other end of each F-shaped member, the dovetail connecting groove and connecting portion of one of the F-shaped members are respectively engaged with the dovetail connecting portion and connecting groove of the other one of the F-shaped members.

13. The single phase permanent magnet brushless motor of claim 1, wherein a gap is defined between the yoke and an inner surface of the outer housing to form an axial passage, the outer housing defines a plurality of openings communicating with the axial passage.

14. The single phase permanent magnet brushless motor of claim 1, wherein the stator further comprises a supporting bracket mounted in the outer housing, and a bearing seat mounted to at least one of the supporting bracket and the outer housing, the rotor comprises a shaft supported by the bearing seat through a bearing.

15. The single phase permanent magnet brushless motor of claim 14, wherein the supporting bracket has a cross shape, a sidewall of the outer housing defines four openings, with connecting walls formed between the openings, the supporting bracket is fixed to the connecting walls by welding.

16. A single phase permanent magnet brushless motor, comprising:
a stator comprising an outer housing, a supporting bracket mounted in the outer housing, a bearing seat mounted to at least one of the supporting bracket and the outer housing, a stator core mounted in the outer housing, and windings wound on the stator core; and
a rotor rotatably coupled to the stator and comprising a shaft being supported by the bearing seat through a bearing.

17. The single phase permanent magnet brushless motor of claim 16, wherein the supporting bracket has a cross shape, a sidewall of the outer housing defines four openings, with connecting walls formed between the openings, the supporting bracket is fixed to the connecting walls by welding.

18. The single phase permanent magnet brushless motor of claim 16, wherein the stator core and the outer housing are connected through welding.
